(19) United States
(12) Patent Application Publication
(10) Pub. No.: US 2010/0247912 A1
(43) Pub. Date: Sep. 30, 2010

(54) Method for Manufacturing LMA Optical Preforms and Fibers

(76) Inventors: Valentin P. Gapontsev, Worcester, MA (US); Volodia Sergueev, Burbach (DE); Nikolai Platonov, Worcester, MA (US)

Correspondence Address: IPG PHOTONICS CORPORATION, 50 OLD WEBSTER ROAD, OXFORD, MA, 01540, US

(21) Appl. No.: 12/409,565

(22) Filed: Mar. 24, 2009

(51) Int. Cl. D02G 3/18; C03B 37/025; C03C 13/04

(52) U.S. Cl. 428/401; 65/412; 501/37

(57) ABSTRACT

A method of producing a large mode area optical preform includes selecting a preexisting rod and at least one preexisting outer tube. The rod and tube are selected so that a difference between respective indices of refraction is uniform and lies within the desired range, and a ratio between respective rod and tube diameters is within the desired range after the rod is inserted into the tube and both are thermally treated. The predetermined ranges are selected to provide mass production of a large mode area fiber with the desired physical and geometrical characteristics.

### BACKGROUND OF THE DISCLOSURE

1. Field of the Disclosure

The disclosure relates to a method of manufacturing a preform for fibers, and in particular, a preform for large mode area (LMA) optical fibers and LMA fibers drawn therefrom.

2. Discussion of Prior Art

The process of manufacturing the preform for optical fibers, doped and passive, has to meet stringent requirements to the refractive indices of the preform components including core and outer cladding or claddings. Different types of fibers have different geometrical and physical characteristics each needed for a given purpose. Some of the known configurations may have higher requirements than other fiber configurations.

For example, LMA fibers are specialty fibers with fiber core geometries ranging from tens to hundreds and even thousands of microns. Of special interest are single-mode (SM) LMA fibers or those LMA fibers which are configured with a multimode core capable of supporting a few modes. As known to one of ordinary skilled worker, the SM fibers provide a diffraction-limited beam which is characteristic of the high quality of light. To achieve such a high quality beam, LMA fibers are configured with a tightly controlled and small difference Δn between the indices of refraction of respective core and cladding regions. The smaller the difference, the larger the mode area, which is particularly advantageous during the assembly of fiber system including LMA fibers. Accordingly, the known methods of making LMA preforms are labor- and time-consuming.

FIG. 1 illustrates a conventional multi-step process for manufacturing a preform 10, which is a template for fiber such a single mode LMA fiber. The first step includes forming a core preform 12 by a modified chemical deposition method or any other deposition method. This step is realized by the depositing of one or more concentric layers on the inner surface of a tube 14. As a result, the core preform includes core 12 which is composed of the deposited layers and a cladding corresponding to tube 14.

In the further step of the known process, during which preform 10 is produced, the clad/core structure is inserted into a second tube 16 which is subsequently heated to collapse onto inner tube 14. Often, at least one third tube is disposed around the previously made structure if the ratio between the core and second tube diameters does not meet the desired reference value, which is particularly important in case of LMA fibers.

The deposition methods, may not provide for the uniform deposition on the layer(s) during the first step of the known process. As a result, a refractive index nc of core typically fluctuates. Hence, it is very difficult to maintain the desired small uniform difference (Δn) between the refractive index of the core produced by deposition methods, which is particularly important in case of LMA fibers, and the refractive index noc of the outer cladding—the utmost outer tube. If the Δn is not small and uniform, although the possibility of obtaining relatively small numerical aperture and large mode area always exists, the desired values of these parameters and their control are practically impossible to obtain.

FIG. 2 illustrates a step index SM LMA fiber produced by known deposition methods. As can be seen the refractive index of the core has a wave-shape form. In other words, the core index is not constant and, therefore, Δn is not uniform which leads to the problems discussed above.

FIG. 3 illustrates the W profile of SM LMA fibers manufactured by known deposition methods. The depressed-clad fiber of FIG. 3 has a core index which may vary thus causing a non-uniform Δn. The W-profile LMA fibers are advantageous over the step-index fibers because they are characterized by acceptable resistance to bending loads, which typically occur during assembly and/or exploitation of fiber devices.

It is, therefore, desirable to provide a method for manufacturing an LMA fiber preform characterized by a substantially uniform and small Δn which is achieved in a relatively simple and reliable manner.

Still another need exists for a process of manufacturing a single mode (SM) LMA fiber preform characterized by the desired small Δn and large mode field diameter.

Still another need exists for an optical fiber with improved physical characteristics manufactured in accordance with the disclosed method.

### SUMMARY OF THE DISCLOSURE

The disclosed method for manufacturing preferably, but not necessarily, a SM LMA preform is characterized by exercising a tight control over physical and geometrical parameters of fiber preform components and simple assembly thereof into a resulting preform and, therefore, fiber. As a consequence, the resulting SM LMA preform/fiber can be mass produced with repeatable desired physical and geometrical parameters.

The method in accordance with the disclosure includes providing a rod with a uniform index of refraction close to the theoretically desired index of refraction. In case of passive, i.e., undoped fibers, the disclosed process does not have a step performed by MCVD or any other deposition technique. If the preform to be manufactured is for active fibers, a plurality of rods are each individually tested and the one with the desired uniform refraction index is selected.

The disclosed method further provides for overcladding the selected rod by at least one tube with a refraction index lower than that one of the rod and desired geometrical parameters known to provide for a fiber with the desired cladding diameter. This step is accomplished by utilizing a known rod-in-tube (RIT) technique. As a result, a SM LMA fiber with the desired small and uniform Δn and desired ratio between the diameters of respective core and outer cladding is produced.

Referring further to SM LMA fibers with the step index profile, it is known to one of ordinary skills in the art that this particular configuration is extremely bend-sensitive and, thus, exhibit substantial light losses during assembly and exploitation of fiber devices. To increase the resistance to bending loads, LMA fibers are preferably configured with a W profile.

The disclosed method allows for producing the LMA fiber with W-profile or clad-depressed. The clad-depressed fiber manufactured by the disclosed method is characterized by the uniform and small Δn between the indices of refraction of respective core and outer cladding regions of the preform. This is attained by providing a rod made from fused silica and, thus, exhibiting a uniform index of refraction. Using the rod in tube (RIT) technology, the rod is inserted into an inner tube which is then heated to collapse onto the rod. As a consequence, the resulting structure includes the core and inner cladding corresponding to the rod and inner tube, respectively. The inner tube is selected with a depressed index which can be achieved, for example, by doping the inner tube with fluorine.

Using the RIT technique, the core/clad structure is inserted into a further, outer tube configured with the index of refraction slightly smaller than that one of the core but higher than the index of the inner tube. The structure is thermally treated to have the outer tube collapse onto the inner tube so as to define the outer cladding of the preform. The LMA W-profile fiber preform thus produced has a tightly controlled and small Δn between the indices of the respective core and outer tube/cladding regions. The small and uniform Δn, in turn, provides for a small numerical aperture and, therefore, large mode area.

The above and other features of the disclosed method will become more readily apparent from the following specific description better understood in conjunction with the drawings.

### BRIEF DESCRIPTION OF THE DRAWINGS

FIG. 1 diagrammatically illustrates the process of the known prior art.

FIG. 2 illustrates an LMA fiber configured with a step index.

FIG. 3 illustrates an LMA fiber configured with a depressed-clad or W index profile.

FIGS. 4 and 5 illustrate the disclosed process for manufacturing fiber with step-index and W-profile, respectively.

FIG. 6 illustrates a step index and W index profile of fiber manufactured in accordance with the technique shown in FIGS. 4 and 5.

FIG. 7 illustrates the dependence of the mode area from the core diameter.

FIG. 8 illustrates a flow chart of the disclosed process.

FIG. 9 illustrates a flow chart of modified steps of the disclosed process.

FIG. 10 diagrammatically illustrates the process of FIG. 9.

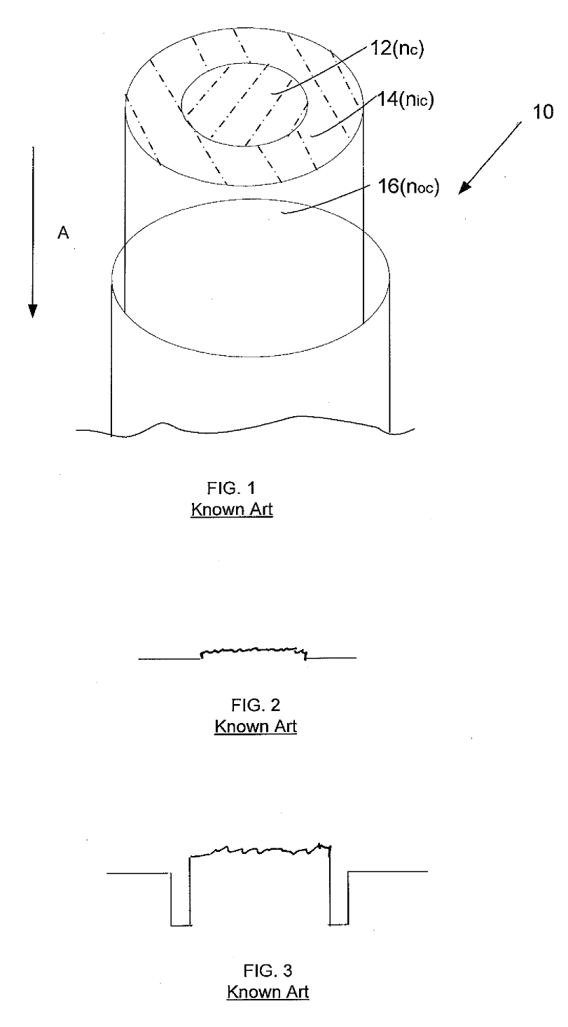

### SPECIFIC DESCRIPTION

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. The word “couple” and similar terms do not necessarily denote direct and immediate connections, but also include connections through intermediate elements or devices.

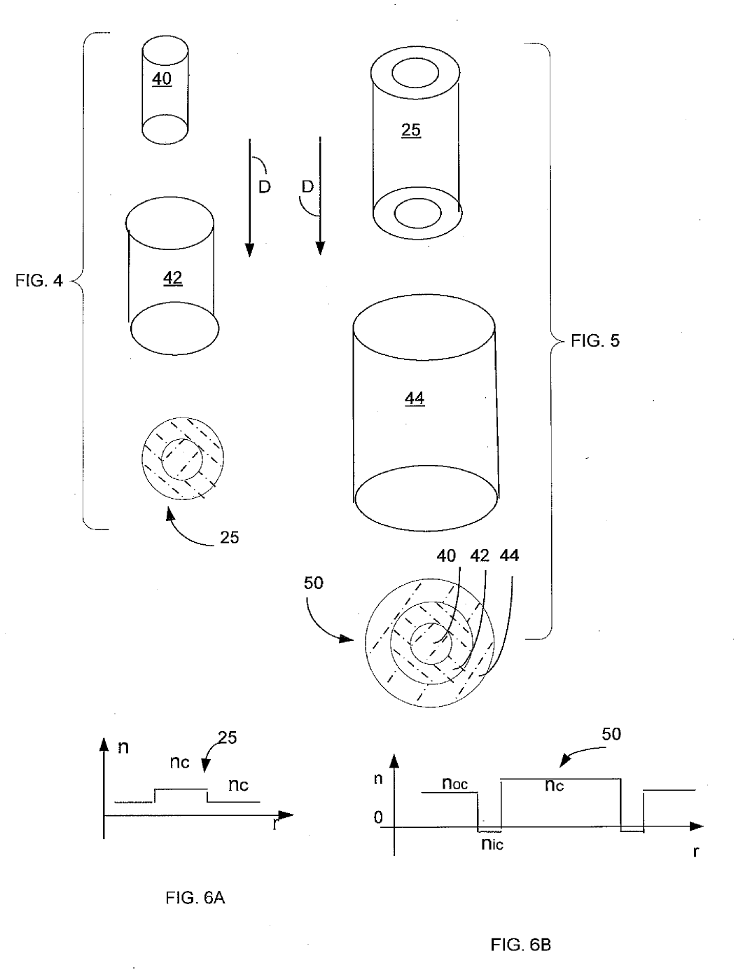

FIGS. 4-6 and 8 illustrate the disclosed process for producing a step-index SM fiber preform 25 having index of refraction nc of the core uniformly greater than the index of refraction ncl of the cladding at a very small value along the entire length of the preform. As a consequence, the disclosed process provides for a small, uniform Δn.

In particular, a rod 40 (FIG. 4) is provided with a uniform index of refraction nc. For passive fibers, rod 40 is configured from fused silica by any known methods, readily realized by one of ordinary skills in the art. None of these known methods includes a step associated with known deposition methods such as MCVD, OVD and others. Since the desired physical and geometrical characteristics of the fiber to be manufactured are known, only the uniformity of the known index of refraction of the rod is determined during step 20 (FIG. 8) by, once again, well known methods readily realized by ordinary skilled worker in the fiber art. The rod 40 may be selected among a plurality of pre-existing quartz rods or among quartz tubes that can be collapsed onto their own to form respective rods.

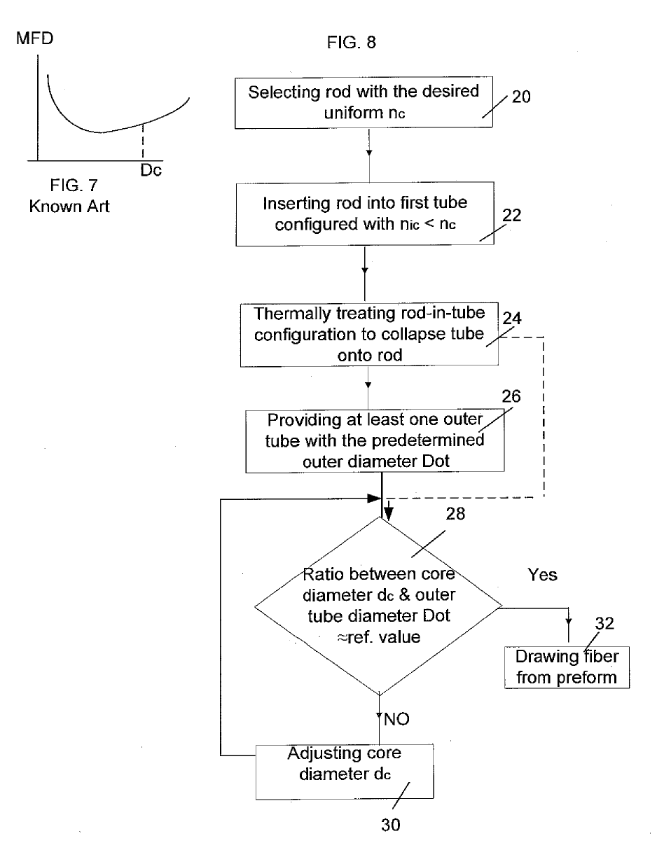

The process continues with step 22 (FIG. 8) during which rod 40 is displaced along direction D (FIG. 4) towards and inserted into a tube 42 using a rod-in-tube method. For single mode fibers it is essential that the ratio between the diameters of the core and cladding lie within a predetermined range allowing to obtain the desired mode area. The diameter of the core is particularly important for single mode LMA fibers. As the name LMA implies, this kind of specialty fibers has is a very specific structural distinction from all other types of fiber. The LMA fiber is configured with a large mode area. In single mode fibers, a mode-field diameter (MFD) depends from the core diameter Dc in accordance with a graph illustrated in FIG. 7. As the core diameter enlarges, the lossless fusion of adjacent fibers in fiber laser systems becomes easier. Yet, limitless enlargement of the core diameter is unrealistic because, at a certain threshold, the fiber may loose its ability to support a single mode.

Returning to the disclosed process, sometimes, selected rod 40 (FIGS. 4 and 5) is configured with the desired core diameter Dc during initial step 20 and satisfies the desired ratio. Frequently, however, the rod does not have the desired diameter. Mainly, it is larger than the desired one, but sometimes it is smaller. The adjustment of the ratio may be accomplished by a variety of techniques allowing to obtain the preform with either a step-index or W-index profile.

When rod 40 is inserted into tube 42, its outer surface is radially spaced from the inner surface of the tube. In other words, the rod/tube configuration has an annular channel between the opposing surfaces of rod 40 and tube 42, respectively. In order to collapse tube 42 onto rod 40 so as to form the core and cladding of preform 25 (FIG. 4), the rod/tube configuration is thermally treated, as illustrated by step 24 with a subsequent determination of the diameters Dc, as shown in step 28 of FIG. 8. As the heat applied to tube 42 and rod 40, tension forces are applied to the components which cause their elongation. As a consequence, the diameter Dc of rod 40 may be controllably reduced to the value allowing for obtaining the desired ratio.

Such an elongation can be provided by any technique known to ordinary skilled worker in the fiber art. For example, the rod structure may be elongated upon disposing the later in a vertical or horizontal re-sleeving lathe, heating the mounted structure while creating a vacuum sufficient to draw the rod. Of course, it is perfectly possible to reduce Dc diameter of rod 40 immediately after it has been formed during initial step 20 and before the insertion of rod 40 into tube 42 (FIG. 4). Alternatively, instead of reducing the core diameter, it is possible to provide an additional cladding in step 26 of FIG. 8, thereby enlarging the clad diameter Dcl. In the embodiment of the disclosed method concerned with a W-profile preform, overcladding with at least one or more outer tubes is critical. As to the step-index, overcladding step 26 may be sometimes omitted. In both cases, however, the outer tubes are of standard sizes which are a priory known to produce the desired outer diameter of fiber drawn from the preform manufactured by the disclosed method. Hence, it is generally easier to deal with the adjustment of the core diameter as indicated in step 30 of FIG. 8 then with the adjustment of outer tubes.

FIGS. 6A and 6B illustrate respective step-index and W profile of the SM LMA preform made in accordance with above-disclosed method. In either case, because of the selected uniformity of index of refraction nc of rod 40, it is easy to see in FIG. 6A that produced fiber preform 25 of FIG. 4 has a substantially uniform Δn. Similarly, the W-profile of FIG. 6B of fiber preform 50 is characterized by a smooth, substantially uniform and small Δn providing for a small numerical aperture and, therefore, large mode area.

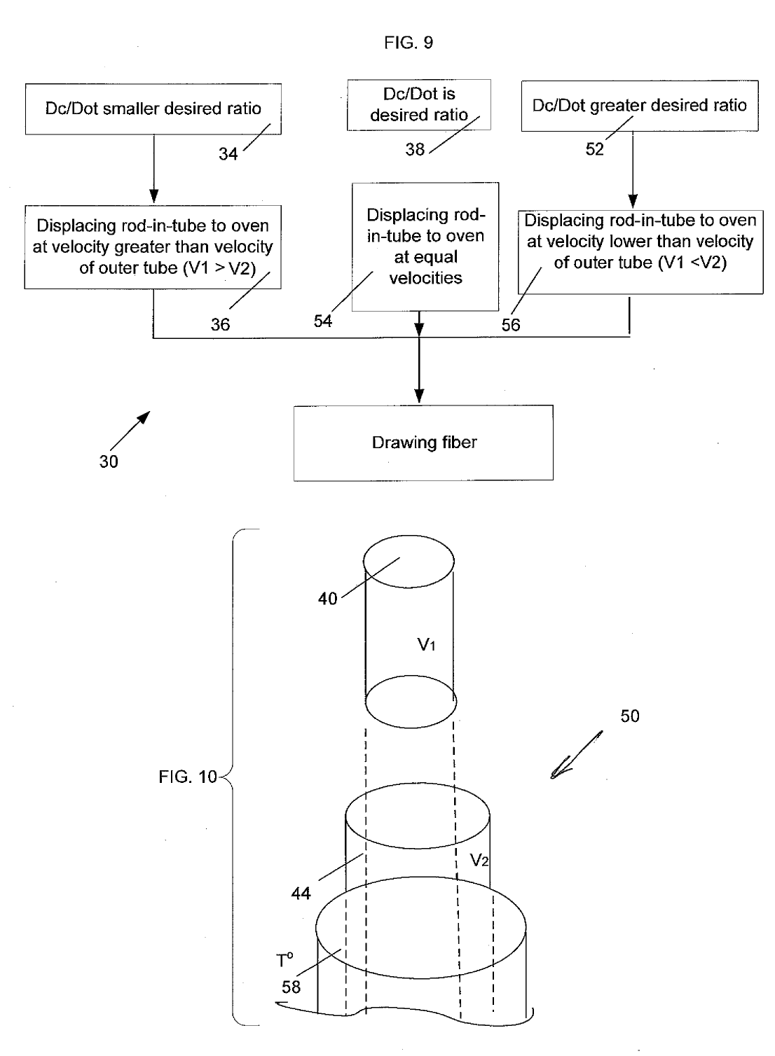

FIGS. 9-10 illustrate a somewhat modified process of forming a preform and fiber drawn from the preform. Initially, the rod-in-tube configuration 25 (FIG. 10) is manufactured in accordance with steps 20-24 and 28 of FIG. 8. Upon determining that the ratio Dc/Docl, adjustment step 30 is realized by different techniques disclosed below.

In accordance with the illustrated modification, rod/core 40 and tube 42 (or 44 depending on the number of components) are displaced toward an oven 58. The oven 58 is not only used for providing a final preform with tube 42 collapsed onto rod 40. The modified step 30 is also characterized by drawing the fiber from the outlet of oven 58 as the preform component are passing through and being coupled within the oven.

The rod 40 and outer tube 46 are delivered into oven 58 by separate delivering mechanisms, such as robotic arms. If prior to the delivery, rod 40 is determined to have the desired diameter Dc (and therefore the ratio Dc/Dcl is within the desired range), the velocities V₁ and V₂ of the respective components will be substantially the same within oven 58, as shown by steps 38 and 54 of FIG. 9.

If rod 40 is determined to have diameter Dc smaller than necessary for obtaining the desired ratio Dc/Dcl, the velocity of delivery V₁ of rod 40 is modified so as to be higher than V₂ of tube 42. This can be, of course, realized be either increasing the velocity of rod 40 while the velocity of tube 43 may remain the same or be decreased. The higher velocity of rod 40 relative to tube 42 leads to the increase in rod diameter Dc.

If, however, rod diameter Dc is larger than the one necessary for obtaining the desired ratio Dc/Dcl the velocity of delivery V₁ of rod 40 is modified so as to be lower than V₂ of tube 42. The lower the velocity of rod 40 relative to tube 42, the smaller rod diameter Dc.

Thus, the disclosed process is realized in a simple manner by first selecting rod 40 made, for example, from fused silica with a uniform refraction index and overcladding the selected rod by either one outer tube or multiple outer tubes. The indices of refraction are so selected that the difference between the indices of the rod and outer tube, respectively, lies within the acceptable range. Due to the thermal treatment, the diameters are reduced to the desired values necessary to receive the required geometry and physical properties of the fiber drawn from the preform. While tubes 42 and 44 (FIGS. 4, 5) have been disclosed to collapse sequentially, it is possible to collapse the tubes onto each other simultaneously. As a result, preferably a single mode step-index or depressed clad fiber preform with the desired Δn and ratio Dc/Dc is produced, as illustrated by the following examples. The disclosed method can be used for manufacturing LMA doped fibers with a particular emphasis on the proper selection of rods with uniform index. The following examples illustrate the above-disclosed process.

Let's assume that there are no available rods and/or tubes with respective precise indices of refraction and geometry necessary to manufacture a preform with the desired parameters. The desired preform/fiber should be a single mode clad-depressed LMA fiber with the core diameter of 15 microns supporting a single mode with MFD of about 14 microns at a 1.07 micron wavelength.

The closest to the desired physical and geometrical characteristics is a readily available rod, such as F300 made from fused silica and thus having a substantially uniform index of refraction nc and known diameter. The inner tube with satisfactory parameters can be for example an easily available quartz tube F325 index of refraction −2.3-−2.4×10⁻³ relative to the nc. The outer tube, for example F320 made from quartz with an index of refraction −1.4-−1.6×10⁻³ relative to the nc is also readily available and, if used as a preform, is known to provide for a standard fiber with a 125 micron outer diameter.

Upon selecting the components, the F300 rod is overclad by the F325 tube which further undergoes a thermal treatment so as to collapse onto the rod. Empirically, for all practical purposes, it is was shown that the original F300 rod should be reduced in diameter in 2.3-2.7 which would be adequate for obtaining a core diameter of about 16 micron. The core of about 16 micron is capable of supporting a single mode with an MFD of about 14 micron provided the outer tube has a diameter within the desired range.

Accordingly, the obtained core/inner cladding preform is further overclad by the selected outer tube F320. Upon collapsing of the outer tube onto the inner tube, a single mode.

If having the same preexisting components, as disclosed immediately above, the F300 rod is reduced to a diameter of about 22 micron, a fiber reliably supporting a single mode with an MFD of about 20 micron at a 1.55 micron wavelength can be mass-produced.

In a further example, it is desirable to make a single mode LMA fiber capable of supporting a single mode with MFD of about 19 is to be received at a 1.07 micron wavelength. Selected are the F300 rod, inner tube F320 with a refraction index of about −1.5×10⁻³ relative to the nc, and outer tube F300 but with an index of refraction −1.4-−1.6×10⁻³ relative to the nc. During the first overcladding by the inner tube, the diameter of initial rod F300 is reduced in about 2.5-3 times to the core diameter of about 21 micron. Further, the outer tube 320 is disposed around the inner tube and further thermally treated. The resulting preform has been proved to provide for drawing the desired SM LMA fiber with the required core and cladding diameters, wherein the core is capable of supporting a single mode with MFD of about 19 micron.

If the F300 rod is reduced to the core of about 29 micron with the rest of components being identical to the preexisting component in the previous example, the resulting fiber supports a single mode with MFD of about 25 micron at a 1.55 micron wavelength.

Furthermore, while the manufacturing of SM LMA fibers is of particular interest, multimode LMA fibers can be produced by the disclosed method.

Although shown and disclosed is what is believed to be the most practical and preferred embodiments, it is apparent that modifications of the disclosed configurations and methods will suggest themselves to those skilled in the art. Thus possible modifications may be used without departing from the spirit and scope of the disclosure defined within the scope of the appended claims.

1. A process for mass producing an LMA optical preform with a predetermined and uniform difference Δn between indices of refraction of respective core and cladding of the optical fiber and a predetermined range ΔD of ratios between diameters of respective cladding and core, the method comprising the steps of:
providing a preexisting elongated rod having a substantially uniform core index of refraction over a length of the rod, the preexisting rod having a rod diameter Dc;
providing at least one preexisting tube having:
a tube diameter Dcl greater than the rod diameter, and
a tube index of refraction smaller than the rod index, a difference between the indices of the respective preexisting rod and one tube being substantially equal to the predetermined Δn;
disposing the elongated rod within the tube to provide a rod-in-tube assembly; and
thermally treating the rode-in-tube assembly so that the tube collapses onto the rod while adjusting the rod and tube diameters so that a ratio Dcl to Dc is substantially within the predetermined range of ratios ΔD, thereby forming the LMA optical preform.

2. The process of claim 1, wherein the ratio between the rod and tube diameters and the difference between the indices of refraction are selected so that the LMA optical preform is configured with the core supporting a single mode with a maximum possible mode area at a desired wavelength.

3. The process of claim 1, wherein the ratio between the rod and tube diameters and the difference between the indices of refraction are selected so that the LMA optical preform is configured with the core supporting multiple modes.

4. The process of claim 1, wherein the rod is made from fused undoped silica so as to provide the LMA optical preform for passive LMA fibers.

5. The process of claim 1, wherein the rod is doped so as to provide for an active configuration of the LMA optical preform for active LMA fibers.

6. The process of claim 1, wherein the LMA optical preform is configured with a step-index profile.

7. The process of claim 1 further comprising:
selecting at least one second tube with a diameter and a second tube refraction index, wherein the second tube refraction index is greater than the tube index and insignificantly smaller than the rod index, and
heating the second tube.

8. The process of claim 7, wherein the heating of the one and second tubes is provided sequentially so that the second tube is collapsed onto the one tube of the rod-in-tube assembly, thereby forming the LMA preform with a W-index profile.

9. The process of claim 7, wherein the heating of the one and second tubes is provided simultaneously to form the LMA preform with a W-index profile.

10. The process of claim 1 further comprising delivering the one tube and rod to a heater while controlling respective velocities.

11. The process of claim 10 further comprising displacing the rod and one tube at substantially equal velocities through the heater if, upon modifying the rod and tube diameters during the heating thereof, the ratio Dcl to Dc is determined to be substantially equal to the predetermined ratio.

12. The process of claim 10 further comprising a step selected from the group consisting of
displacing the preexisting rod at a velocity higher than that one of the preexisting tube, if, upon modifying the rod and tube diameters, during the heating thereof, the ratio Dcl to Dc is determined to be greater than the predetermined ratio; and
displacing the preexisting rod at the velocity lower than that one of the preexisting tube, if, upon modifying the rod and tube diameters during the heating thereof, the ratio Dcl to Dc is determined to be smaller than the predetermined ratio.

13. A large mode area (LMA) optical preform comprising:
a preexisting rod having a rod diameter Dc and a rod index of refraction nc; and
at least one preexisting tube disposed around the preexisting rod and coupled thereto, the one preexisting tube being provided with a tube diameter and a tube index of refraction, the rod and tube indexes being selected so that a difference therebetween is uniform and lies within a predetermined range Δn, the preexisting rod and one tube being heated to set in the LMA preform with the rod and tube diameters reduced so that a ratio therebetween lies within a predetermined range ΔD.

14. The LMA preform of claim 13, wherein the predetermined ratio ΔD and the predetermined difference Δn are selected so that the LMA optical preform is configured for drawing an LMA fiber selected from the group consisting of single mode LMA fiber and multimode LMA fiber.

15. The LMA preform of claim 13, wherein the LMA preform is configured for drawing an LMA fiber selected from the group consisting of passive and active fibers.

16. The LMA preform of claim 13, wherein the LMA optical preform is configured with a step-index profile.

17. The LMA preform of claim 13 further comprising at least one second preexisting tube surrounding and coupled to the one tube and configured with a respective index of refraction which is selected so that the LMA preform has a W-index profile.

18. The LMA preform of claim 17, wherein the LMA preform is configured to produce a single mode LMA fiber upon collapsing the second tube onto the one tube, the single mode LMA fiber having a configuration selected from the group consisting of:
a core diameter of about 16 microns and a mode field diameter (MFD) of about 14 microns at about 1.07 micron wavelength; and
a core diameter of about 22 microns and a mode field diameter (MFD) of about 20 microns at about 1.55 micron wavelength.

19. The LMA preform of claim 17, wherein the LMA preform is configured to produce a single mode LMA fiber with a configuration selected from the group consisting of
a core diameter of about 21 and a mode field diameter (MFD) of about 19 microns at about 1.07 micron wavelength, and
a core diameter of about 29 microns and a mode field diameter (MFD) of about 25 microns at about 1.55 micron wavelength.

20. The LMA preform of claim 17, wherein the preexisting rod is an F300, the one tube is selected from an F325 or F320, and the second tube is selected from an F320 or F300.
